(19) United States
(12) Patent Application Publication
(10) Pub. No.: US 2026/0020516 A1
(43) Pub. Date: Jan. 22, 2026

(54) SEED TREATMENT COMPOSITION AND METHOD OF USING

(71) Applicant: KOCH AGRONOMIC SERVICES, LLC, Wichita, KS (US)

(72) Inventors: Robert A. Geiger, Denton, TX (US); Steffen M. Ball, Kansas City, MO (US); Renil John Anthony, Lenexa, KS (US); Andres Reyes Gaige, Overland Park, KS (US)

(21) Appl. No.: 19/341,604

(22) Filed: Sep. 26, 2025

Related U.S. Application Data
(62) Division of application No. 17/130,501, filed on Dec. 22, 2020.
Application No. 17/130,501 is a division of application No. 16/555,231, filed on Aug. 29, 2019, now abandoned.
(60) Provisional application No. 62/724,439, filed on Aug. 29, 2018.

(51) Int. Cl. A01C 1/06

(52) U.S. Cl. CPC A01C 1/06

(57) ABSTRACT

The present disclosure provides a new seed treatment composition for use as a flow aid or seed lubricant. The composition comprises ground corn components and preferably one or more nutrients. The composition can be applied to wet or dry seeds, minimizing or preventing sticking, bridging, and clumping of the seeds during planting or treatment processes. Advantageously, these compositions also improve plant growth while minimizing waste and missed seed pick-up by the planter.

### RELATED APPLICATIONS

The present application is a divisional application of U.S. patent application Ser. No. 16/555,231, entitled SEED TREATMENT COMPOSITION AND METHOD OF USING, filed Aug. 29, 2019, and incorporated by reference herein. U.S. patent application Ser. No. 16/555,231 claims the priority benefit of U.S. Provisional Patent Application Ser. No. 62/724,439, filed Aug. 29, 2018, entitled SEED TREATMENT COMPOSITION AND METHOD OF USING, incorporated by reference in its entirety herein.

### BACKGROUND OF THE INVENTION

### Field of the Invention

The present disclosure broadly relates to a novel seed treatment composition and a method of using that composition as a seed lubricant to improve seed flow.

### Description of the Prior Art

Seed lubricants or flow aids have been used in an attempt to decrease the friction between seeds and machinery so as to provide a consistent flow of seed through the treatment or planter equipment. However, the flow aids that have been used present drawbacks. For example, talc has been used in the past, but the dust presents health concerns. Graphite has also been utilized but has electrical issues due to its conductive nature. Finally, the use of waxes as seed flow aids is expensive, making them more difficult to afford for many growers.

There is a need for cost-effective seed treatment compositions that have good flowability while avoiding the health and safety concerns of the prior art.

### SUMMARY OF THE INVENTION

The present disclosure fills a need in the art by broadly providing a method of improving seed flow comprising contacting a seed having an outer surface with a seed treatment composition. The seed treatment composition comprises ground corn components, and the contacting is carried out so that the seed treatment composition coats at least some of the outer surface. The seed treatment composition comprises at least about 20% by weight of the ground corn components, based upon the total weight of the seed treatment composition taken as 100% by weight.

The present disclosure is also concerned with a seed comprising a seed treatment composition on at least some of the outer surface of the seed. The seed treatment composition comprises at least about 20% by weight ground corn components, based upon the total weight of the seed treatment composition taken as 100% by weight.

The present disclosure is also directed towards a seed treatment composition comprising ground corn components and a plant nutrient selected from the group consisting sources of macronutrients and micronutrients. The seed treatment composition comprises at least about 35% by weight of the plant nutrient and less than about 5% by weight moisture, wherein all % by weight are based upon the total weight of the seed treatment composition taken as 100% by weight.

### BRIEF DESCRIPTION OF THE DRAWINGS

FIG. 1 is a graph showing the results of the flow cone study described in Example 2;

FIG. 2 is a graph depicting the singulation comparison testing described in Example 3;

FIG. 3 is a graph comparing the misses during planting of wet seeds during the Example 3 testing;

FIG. 4 is a photograph of the Blend 8 test plants shortly after emergence, as described in the field trials of Example 4;

FIG. 5 is a photograph comparing plants grown from the Blend 8 seeds (left) to those grown from control seeds (right), as described in the field trials of Example 4:

FIG. 6 is a graph showing the plant height of plants grown from seeds treated as described in Example 5:

FIG. 7 is a graph depicting the root area of plants grown from seeds treated as described in the Example 5;

FIG. 8 is a graph depicting the biomass of plants grown from seeds treated as described in Example 5;

FIG. 9 shows the macronutrient uptake of the various test plants (Example 5);

FIG. 10 depicts the micronutrient uptake of the various test plants (Example 5);

FIG. 11 shows a comparison of the nitrogen uptake of the test plants from Example 5;

FIG. 12 shows a comparison of the phosphorus uptake of the test plants from Example 5;

FIG. 13 shows a comparison of the zinc uptake of the test plants from Example 5;

FIG. 14 shows a comparison of the manganese uptake of the test plants from Example 5;

FIG. 15 is a graph showing the results of the flow cone study described in Example 7;

FIG. 16 is a graph depicting the root area of plants grown from seeds treated as described in the Example 8;

FIGS. 17(a) and (b) are photographs showing the roots of two test plants at 6 weeks after emergence (Example 8);

FIG. 18 is a graph showing nodule counts of plants grown from seeds treated as described in Example 8;

FIG. 19 is a graph depicting the biomass of plants grown from seeds treated as described in Example 8;

FIG. 20(a) shows the nitrogen and phosphorus uptakes of the test plants of Example 8;

FIG. 20(b) shows the zinc and manganese uptakes of the test plants of Example 8;

FIG. 20(c) shows the molybdenum uptake of the test plants of Example 8;

FIG. 21(a) is a graph depicting the biomass of plants grown from seeds treated as described in Example 9;

FIG. 21(b) is a graph depicting the shoot biomass of plants grown from seeds treated as described in Example 9;

FIG. 21(c) is a graph depicting the root biomass of plants grown from seeds treated as described in Example 9;

FIG. 22(a) shows the nitrogen uptake of the test plants of Example 9;

FIG. 22(b) shows the phosphorus uptake of the test plants of Example 9,

FIG. 22(c) shows the zinc and manganese uptakes of the test plants of Example 9; and

FIG. 22(d) shows the molybdenum uptake of the test plants of Example 9.

### DETAILED DESCRIPTION OF THE PREFERRED EMBODIMENTS

### Inventive Seed Treatment Compositions

In more detail, the inventive seed treatment generally comprises a ground corn component and a plant nutrient.

The ground corn component is preferably present in the seed treatment composition in an amount of at least about 20% by weight, preferably at least about 25% by weight, more preferably at least about 35% by weight, even more preferably from about 40% to about 80% by weight, and even more preferably from about 45% to about 70% by weight, based upon the total weight of the seed treatment composition taken as 100% by weight. Suitable ground corn components include, but are not limited to, those selected from the group consisting of cornmeal (which encompasses corn flour), corn starch, and mixtures thereof. In one embodiment, a mixture of corn starch and cornmeal is utilized. In another embodiment, the seed treatment composition consists essentially of, or even consists of (i.e., only includes), the ground corn components.

It is preferred that the starch present in the ground corn components has not been modified in any way. For example, it is preferred the starch molecules have not been grafted or otherwise reacted with any compounds or polymers (particularly non-starch polymers).

In a preferred embodiment, the plant nutrient of the seed treatment composition is selected from the group consisting of sources of macronutrients, micronutrients, and mixtures thereof. As used herein, “macronutrient” refers to elements typically required in large quantities for plant growth, with preferred macronutrients being those selected from the group consisting of calcium, sulfur, phosphorus, magnesium, potassium, nitrogen, sodium, and mixtures thereof. “Micronutrient” refers to elements typically required in small or trace amounts for plant growth, with preferred macronutrients being those selected from the group consisting of nickel, copper, zinc, manganese, boron, iron, cobalt, selenium, molybdenum, and mixtures thereof. In both instances, a “source” of a macronutrient or micronutrient is meant to refer to a compound containing the element (e.g., CaCO₃) or the element itself (e.g., Ca), unless stated otherwise.

It will be appreciated that the respective quantities of macronutrient sources and/or micronutrient sources can be adjusted depending upon the type of seed, soil conditions, etc., but in this embodiment it is preferred that the overall total quantity of all macronutrient and micronutrient sources in the seed treatment composition is from about 25% to about 75% by weight, preferably from about 30% to about 70% by weight, and more preferably from about 30% by weight to about 55% by weight, based upon the total weight of the seed treatment composition taken as 100% by weight. In another embodiment, the overall total quantity of all macronutrient and micronutrient sources in the seed treatment composition is at least about 25% by weight, preferably at least about 35% by weight, and more preferably at least about 45% by weight, based upon the total weight of the seed treatment composition taken as 100% by weight.

The preferred quantities of typical macronutrients and micronutrients are shown in Table A.

TABLE A

| PLANT | BROADEST | | MOST |
|---|---|---|---|
| NUTRIENT* | RANGE** | PREFERRED** | PREFERRED** |
| Calcium (Ca) | about 0.001% to | about 0.01% to | about 0.01% to |
| | about 45% | about 25% | about 15% |
| Sulfur (S) | about 0.001% to | about 0.01% to | about 0.01% to |
| | about 45% | about 25% | about 15% |
| Magnesium (Mg) | about 0.001% to | about 0.01% to | about 0.01% to |
| | about 45% | about 25% | about 15% |
| Potassium (K) | about 0.001% to | about 0.01% to | about 0.01% to |
| | about 45% | about 25% | about 15% |
| Nitrogen (N) | about 0.001% to | about 0.01% to | about 0.01% to |
| | about 45% | about 25% | about 15% |
| Sodium (Na) | about 0.001% to | about 0.01% to | about 0.01% to |
| | about 45% | about 25% | about 15% |
| Nickel (Ni) | about 0.001% to | about 0.01 to | about 0.01% to |
| | about 45% | about 25% | about 15% |
| Copper (Cu) | about 0.001% to | about 0.01% to | about 0.01% to |
| | about 45% | about 25% | about 15% |
| Zinc (Zn) | about 0.001% to | about 0.01% to | about 0.01% to |
| | about 45% | about 25% | about 15% |
| Manganese (Mn) | about 0.001% to | about 0.01% to | about 0.01% to |
| | about 45% | about 25% | about 15% |
| Boron (B) | about 0.001% to | about 0.01% to | about 0.01% to |
| | about 45% | about 25% | about 15% |
| Iron (Fe) | about 0.001% to | about 0.01% to | about 0.01% to |
| | about 45% | about 25% | about 15% |
| Cobalt (Co) | about 0.001% to | about 0.01% to | about 0.01% to |
| | about 45% | about 25% | about 15% |
| Selenium (Se) | about 0.001% to | about 0.01% to | about 0.01% to |
| | about 45% | about 25% | about 15% |
| Molybdenum (Mo) | about 0.001% to | about 0.01 to | about 0.01% to |
| | about 45% | about 25% | about 15% |

*In embodiments where the particular nutrient is present (i.e., when it is not 0%).
**AU ranges refer to the weight of the target nutrient rather than the source of the target nutrient, with % by weight being based upon the total weight of the seed treatment composition taken as 100% by weight.

In one embodiment, it is preferred that the seed treatment composition is essentially free of one, two, three, or four of the following: waxes, carbonaceous materials (e.g., graphite or other materials whose weight is at least 90% attributable to carbon), silicon-containing compounds (e.g., silicates such as talc, clays such as montmorillonite, kaolinite, and bentonite), microorganisms, and polymers other than those naturally present in ground corn components. In these such embodiments, the seed treatment composition comprises less than about 5% by weight total, preferably less than about 3% by weight total, and more preferably about 0% by weight total of one, two, three, or four of the foregoing, based upon the total weight of the seed treatment composition taken as 100% by weight.

Even more preferably, the seed treatment composition is essentially free of all five of waxes, carbonaceous materials, silicon-containing compounds, microorganisms, and polymers other than those naturally present in ground corn components. Thus, the cumulative total of the foregoing is less than about 5% by weight, preferably less than about 3% by weight, and more preferably about 0% by weight, based upon the total weight of the seed treatment composition taken as 100% by weight.

In one embodiment, the seed treatment composition consists essentially of, or even consists of (i.e., only includes), the ground corn components and the plant nutrient(s).

In an alternative embodiment, the seed treatment composition further comprises mica, and more preferably mica that is coated with TiO₂. The ground corn components and plant nutrient(s) are preferably present in the ranges discussed previously. Preferred individual plant nutrient levels are as shown in Table A.

In a further embodiment, the seed treatment composition further comprises mica, and more preferably mica that is coated with TiO₂. In this embodiment, however, the ground corn components are preferably present at levels of from about 10% by weight to about 90% by weight, more preferably from about 15% by weight to about 50% by weight, and even more preferably from about 20% by about 35% by weight, based on the total weight of the seed treatment composition taken as 100% by weight. It will be appreciated that the respective quantities of macronutrient sources and/or micronutrient sources can be adjusted depending upon the type of seed, soil conditions, etc., but in this embodiment it is preferred that the overall total quantity of all macronutrient and micronutrient sources in the seed treatment composition is from about 10% to about 60% by weight, preferably from about 30% to about 60% by weight, and more preferably from about 40% by weight to about 50% by weight, based upon the total weight of the seed treatment composition taken as 100% by weight.

Regardless of which of the two above-discussed TiO₂-coated mica embodiments is utilized, it is preferred that the TiO₂-coated mica is present at levels of from about 1% to about 50% by weight, preferably from about 5% to about 40% by weight, and more preferably from about 10% by weight to about 35% by weight, based upon the total weight of the seed treatment composition taken as 100% by weight. Additionally, a dye or colorant is optionally included, and when it is included, it is present at levels of from about 0.1% to about 15% by weight, preferably from about 1% to about 10% by weight, and more preferably from about 1% by weight to about 5% by weight, based upon the total weight of the seed treatment composition taken as 100% by weight.

In a further embodiment, the seed treatment composition consists essentially of, or even consists of (i.e., only includes), the ground corn components, plant nutrient(s), TiO₂-coated mica, and optionally a dye or colorant.

In another embodiment, optional ingredients can be added, such as those selected from the group consisting of biostimulants, microorganisms, dispersants, inoculants, and anti-caking agents. Regardless of whether optional ingredients are included, in embodiments where a nutrient is present, it is preferred that the weight ratio of ground corn components to total weight of all sources of macronutrients and micronutrients be from about 1:2.5 to about 3:1, preferably from about 1:1.2 to about 2:1, and more preferably from about 1:1 to about 1.5:1.

Advantageously, each ingredient utilized to form the seed treatment composition is provided in powder or particulate form. The average particle size of each ingredient utilized should be less than about 175 μm, preferably from about 25 μm to about 175 μm, and more preferably from about 100 μm to about 160 μm. In one embodiment, at least about 50%, preferably at least about 70%, more preferably at least about 85%, even more preferably at least about 95%, and most preferably about 100% of the particles in the fertilizer composition will have a particle size in this range. The particle size is determined by conventional methods, including by simply passing the particles through an analytical sieve to screen out particles having an undesirable size. Additionally, the ingredients can be individually subjected to a particular size reduction process (e.g., milling) to achieve these sizes, or the formulation can be prepared followed by particle size reduction of the entire formulation.

It is preferred that the seed treatment compositions are provided in a dry, particulate form. That is, the seed treatment composition will have a moisture content of less than about 5% by weight, preferably less than about 3% by weight, more preferably less than about 1% by weight, and preferably about 0% by weight, based upon the total weight of the seed treatment composition taken as 100% by weight. These levels can be achieved by providing the individual ingredients in a substantially dry form or by drying the final composition to these levels.

In another embodiment, the ground corn components can be replaced or supplemented with another source of starch. That starch could be a vegetable starch such as starches selected from the group consisting of potato starch, pea starch, sweet potato starch, bean starch, chickpea starch, squash starch, yam starch, and mixtures thereof. Other acceptable starches include cereal starches such as those selected from the group consisting of wheat starch, rice starch, tapioca starch, rye starch, oat starch, barley starch, sorghum starch, and mixtures thereof. These other starches are also preferably unmodified, as discussed previously with respect to the corn starch present in the ground corn components.

Finally, the seed treatment compositions are prepared by simply blending the ingredients described above to form a substantially homogenous mixture. As noted above, these ingredients are subjected to particle size reduction prior to blending, as needed. Alternatively, or additionally, particle size reduction of the final mixture can be carried out after it is prepared.

In a further embodiment, the seed treatment comprises about 55% by weight ground corn components and about 45% by weight plant nutrients, based upon the total weight of the seed treatment composition taken as 100% by weight. Of the total plant nutrients present in this embodiment, about 25% by weight is P₂O₅, about 20% by weight is zinc, about 5% by weight is manganese, and about 4% by weight is nitrogen.

### Methods of Using Inventive Seed Treatment Compositions

The method of using the inventive compositions comprises contacting a seed or plurality of seeds with the seed treatment composition so that the seed treatment composition coats at least some of the outer surface of each seed, and preferably the majority of the respective outer surfaces of the seeds. That is, the average outer surface is at least about 50% coated, preferably at least about 75% coated, more preferably at least about 90% coated, and even more preferably about 100% coated with the seed treatment composition. This contacting preferably occurs before contact of the seed with soil so that the seeds are coated with the seed treatment composition prior to planting.

It will be appreciated that the application rate can be adjusted as deemed necessary for the particular seed and other conditions. Typically, this results in an application rate of from about 0.2 grams to about 4 grams per kg of seed, preferably from about 1 to about 4 grams per kg of seed, and more preferably from about 2 to about 4 grams per kg seed. Alternatively, the rate would be from about 0.02% by weight to about 0.4% by weight, preferably from about 0.1% by weight to about 0.4% by weight, and more preferably from about 0.2% by weight to about 0.4% by weight, based upon the total weight of the seed taken as 100% by weight.

This process can be carried out by any conventional seed-coating process, including using a hopper box, planter box, batch seed treater, or blender. Additionally, the seed treatment composition can be applied to dry seeds or wet seeds and can be used with any seed in need of flow aid improvement, including those selected from the group consisting of corn seeds, soybean seeds, cotton seeds, fruit seeds, wheat seeds, and vegetable seeds. Preferably, the seed is a seed other than sunflower seeds or nuts in the culinary sense (e.g., almonds, Brazilian nuts, cashews, coconuts, peanuts, macadamia nuts, and/or pistachios). The coated seeds can be planted following conventional planting processes. This can take place immediately after coating, or the coated seeds can be stored for planting at a later date.

It will be appreciated that the present disclosure provides a number of advantages. For example, dry seeds coated with the seed treatment composition will have a singulation rate or percent singulation (determined as described in Example 3) of at least about 95%, preferably at least about 98%, and more preferably at least about 99%. Wet seeds coated with the seed treatment composition will have a singulation rate of at least about 93%, preferably at least about 95%, and more preferably at least about 97%.

Another advantage of the present disclosure is the improvement in plant growth. The improvement in plant growth can be measured by plant height, average root area, or overall plant mass. For example, at 3 weeks after planting, the average plant height (determined as described in Example 5) of plants grown from seeds coated with the inventive seed treatment composition will be at least about 8% taller, preferably at least about 10% taller, more preferably at least about 13% taller, even more preferably from about 15% to about 75% taller, and most preferably from about 20% to about 50% taller than if the seeds had been planted without any treatment and grown in the same environment (including same pot size, if applicable) and under the same conditions as the test. The roots will also be healthier and more robust. At 3 weeks after planting, the average root area (determined as described in Example 5) of plants grown from seeds coated with the inventive seed treatment composition will be at least about 75% greater, preferably at least about 90% greater, more preferably about 100% greater, and even more preferably about 110% greater than if the seeds had been planted without any treatment.

The disclosure also improves plant uptake of macronutrients and micronutrients noted previously, regardless of whether the particular macronutrient or micronutrient was part of the seed treatment composition. This is particularly true for phosphorus and zinc uptake in plants grown from seeds using the inventive seed treatment composition. That is, zinc levels are known to decrease as phosphorus levels increase, yet embodiments of the present disclosure retain and/or improve zinc uptake.

In one embodiment, following the teachings of the present disclosure results in a nitrogen uptake increase of at least about 3%, preferably at least about 7%, more preferably at least about 10%, and even more preferably at least about 15% as compared to plants grown under the exact same conditions but without the treatment of the present disclosure.

In another embodiment, following the teachings of the present disclosure results in a phosphorus uptake increase of at least about 6%, preferably at least about 9%, and more preferably at least about 11% as compared to plants grown under the exact same conditions but without the treatment of the present disclosure.

In yet another embodiment, the present disclosure results in a zinc uptake increase of at least about 7%, preferably at least about 12%, more preferably at least about 15%, and even more preferably at least about 20% as compared to plants grown under the exact same conditions but without the treatment of the present disclosure. Advantageously, the improvement in zinc uptake achieved can even be at least about 30%, preferably at least about 35%, and more preferably at least about 40% in situations where the plant has been treated with an inoculant (e.g., bradyrhizobium) as compared to inoculant treatment but without using the seed treatment composition according to the invention.

In another embodiment, the present disclosure results in a manganese uptake increase of at least about 5%, preferably at least about 9%, and more preferably at least about 12% as compared to plants grown under the exact same conditions but without the treatment of the present disclosure. Advantageously, the improvement in manganese uptake achieved can even be at least about 30%, preferably at least about 35%, and more preferably at least about 39% in situations where the plant has been treated with an inoculant (e.g., bradyrhizobium) as compared to inoculant treatment but without using the seed treatment composition according to the invention.

In further embodiment, following the teachings of the present disclosure results in a molybdenum uptake increase of at least about 10%, preferably at least about 16%, more preferably at least about 20%, and even more preferably at least about 25% as compared to plants grown under the exact same conditions but without the treatment of the present disclosure. Advantageously, the improvement in molybdenum uptake achieved can even be at least about 35%, preferably at least about 50%, more preferably at least about 75%, and even more preferably at least about 95% in situations where the plant has been treated with an inoculant (e.g, bradyrhizobium) as compared to inoculant treatment but without using the seed treatment composition according to the invention.

It is particularly preferred that the foregoing increased uptake ranges be achieved when the plant is a corn plant or a soybean plant.

Finally, another advantage of the seed treatment composition of the present disclosure is that the benefits are achieved in a cost-effective manner while avoiding the health, environmental, electrical interference, and other issues of prior art seed lubricants or flow aids.

Additional advantages of the various embodiments of the invention will be apparent to those skilled in the art upon review of the disclosure herein and the working Examples below. It will be appreciated that the various embodiments described herein are not necessarily mutually exclusive unless otherwise indicated herein. For example, a feature described or depicted in one embodiment may also be included in other embodiments but is not necessarily included. Thus, the present disclosure encompasses a variety of combinations and/or integrations of the specific embodiments described herein.

As used herein, the phrase “and/or,” when used in a list of two or more items, means that any one of the listed items can be employed by itself or any combination of two or more of the listed items can be employed. For example, if a composition is described as containing or excluding components A, B, and/or C, the composition can contain or exclude A alone; B alone; C alone; A and B in combination; A and C in combination; B and C in combination, or A, B, and C in combination.

All ranges provided herein include each and every value in the range as well as all sub-ranges there-in-between as if each such value or sub-range was disclosed. Additionally, such ranges are to be construed as providing literal support for claim limitations that only recite the lower value of the range as well as claim limitations that only recite the upper value of the range. For example, a disclosed numerical range of about 10 to about 100 provides literal support for a claim reciting “greater than about 10” (with no upper bounds) and a claim reciting “less than about 100” (with no lower bounds).

Further, all aspects and embodiments of the disclosure comprise, consist essentially of, or consist of any aspect or embodiment, or combination of aspects and embodiments disclosed herein.

### EXAMPLES

The following examples set forth methods in accordance with the disclosure. It is to be understood, however, that these examples are provided by way of illustration and nothing therein should be taken as a limitation upon the overall scope of the disclosure.

### Growers Standard Practice

### 1. Corn

For the following Examples where corn was the test plant, each seed (regardless of whether test seed or control seed) was planted in an 8-inch garden pot that was filled with 1 kg of top soil (Garden Magic from Michigan Peat Company). A base fertilizer of 200-100-100 (water solution that is made from urea, potassium sulfate, and monoammonium phosphate) per acre was applied per pot before planting. Approximately 80 ml of water was added per day, and every 2 weeks the base fertilizer was added again. The remaining procedures, treatments, and conditions are described in each Example.

### 2. Soybeans

For the following Examples where soybeans were the test plant, each seed (regardless of whether test seed or control seed) was planted in an 8-inch garden pot that was filled with 1 kg of top soil (Garden Magic from Michigan Peat Company). A base NPK fertilizer of 40-100-100 (water solution that is made with urea, potassium sulfate, and monoammonium phosphate) per acre was applied per pot before planting. Approximately 80 mL of water was added per day, and every 2 weeks a base PK fertilizer of 0-100-100 (water solution that is made from PeKacid from ICL and potassium sulfate) is added. The remaining procedures, treatments, and conditions are described in each Example.

### Example 1

### Test Blends

Eleven formulations were prepared by first individually grinding the ingredients with a coffee grinder to a particle size of about 149 μm (100 mesh) or smaller. Each individually ground ingredient was then mixed together until substantially homogeneous mixtures were achieved. These formulations are shown in Table 1. In Examples 1-5, references to any of Blends 1-11 are referring to those of Table 1.

TABLE 1

| | Blend 1 | | Blend 2 | Blend 3 | Blend 4 | Blend 5 | Blend 6 | | Blend 7 | Blend 8 | Blend 9 | Blend 10 | | Blend 11 |
|---|---|---|---|---|---|---|---|---|---|---|---|---|---|---|
| Corn | 100 | g | | | | 100 g | 40 | g | 25 g | 50 g | 50 g | 50 | g | 50 g |
| Starch^{A} | | | | | | | | | | | | | | |
| Sipernat ® | 10 | g | | | | | | | | | | | | |
| 22S^{B} | | | | | | | | | | | | | | |
| Graphite^{C} | 25 | g | 10 g | 35 g | 35 g | 10 g | | | | | | | | |
| Humic | 7-5 | g | 20 g | 25 g | 15 g | 25 g | 5 | g | | | | 12.5 | g | 25 g |
| Acid^{D} | | | | | | | | | | | | | | |
| Kelp Meal^{E} | 7.5 | g | 20 g | 25 g | 15 g | 25 g | | | | | | 12.5 | g | |
| Corn Flour^{F} | 25 | g | 25 g | | | | 5 | g | 5 g | 5 g | | 5 | g | |
| CaCO₃ | | | 100 g | 100 g | 100 g | | | | | | | | | |
| HFCS | | | | | | | 5 | g | | | | | | |
| Powder^{G} | | | | | | | | | | | | | | |
| Nu-Trax | | | 25 g | 15 g | 35 g | 40 g | 40 | g | 70 g | 45 g | 50 g | 20 | g | 25 g |
| P+ ®^{,H} | | | | | | | | | | | | | | |
| Rice Hulls^{I} | | | | | | | 5 | g | | | | | | |

^{A}Obtained from ARGO ®, MFG #2001567; UPC #761720073209.
^{B}Silica product obtained from Evonik.
^{C}Sold under the name Natural Graphite by Seed Silk.
^{D}Sold under the name Activ80 GG by Blackearth.
^{E}Sold under the name Kelp Meal by Maxicrop.
^{F}Maseca ® Instant Masa Corn Flour, by Aztec Milling LP. Similar results were obtained with cornmeal (Stone Ground Cornmeal, white, by Palmetto Farms).
^{G}Sold under the name Hi-Sweet by LorAnn Oils.
^{H}Includes sources of P, N, Mn, and Zn, obtained from Compass Minerals, Inc., Overland Park, KS.
^{I}Sold under the name Rice Hulls by LD Carlson.

### Example 2

### Flow Cone Studies

In each run of this test, flow cone studies were carried out to compare the formulations of Example 1 to a control as well as to several prior art treatments. In each instance, 1 kg of dry corn seeds was treated with the formulation to be tested by coating the seeds with 1 to 2 grams of the particular test treatment by shaking the treated corn in a large plastic bag. The control sample was 1 kg of dry corn seeds that received no seed flow aid treatment. These samples were used for the “dry” testing in the flow cone studies.

For the “wet,” studies, additional 1 kg samples were treated as described in the preceding paragraph except that 4 ml of water was added to the seeds after treatment but prior to the flow cone testing was carried out. Again, in this instance, the control sample did not receive a treatment coating, but it did have 4 ml of water added to it prior to flow cone testing.

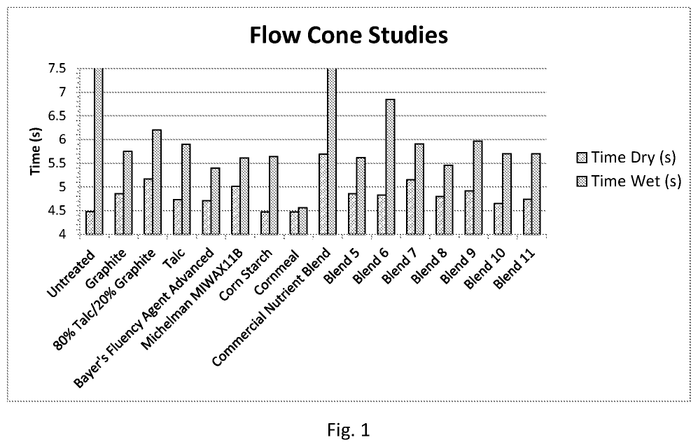

Flow cone testing of the samples was carried out using a large plastic funnel that had an angle of 110° with a 1.5-inch opening for the seeds to flow through. The opening was sealed with tape, and the tape was removed to initiate the test where time was measured until the cone was empty. The corn seed used for testing was from Elk Mound Seed company (EMS 7915 conventional corn seed). The results of this testing are shown in FIG. 1. The untreated (control) test seeds and Commercial Nutrient Blend didn't flow when wet, so the flow testing couldn't be performed on those samples. For graphical purposes, this lack of flowing is shown in FIG. 1 by a number greater than the maximum displayed time of 7.5 seconds.

Overall, these results show that the inventive blends present viable alternatives to prior art graphite, waxes, and talc products but without the downsides of those products and offers a nutritional package that normally has detrimental effects as a seed lubricant.

### Example 3

### Singulation Testing

Corn seed samples (wet and dry) were prepared as described in Example 2 using 2 g of treatment sample in each instance. These samples were subjected to singulation testing by using a Precision Planter MeterMax® Ultra test stand and configured with a vacuum planter with a vSet Classic Corn Crop Kit (730135) (Wolf AG Precision Planting, Claremont, MN). The relevant parameters/settings were: speed of 7 mph; test length 1,000 seeds, 33,000 population with a row spacing of 30 inches; and vacuum target of 16.4. This equipment is a planter simulator that determines the number of times that a single seed is successfully picked up and fed to the seed tube. It is desired to have the highest singulation possible.

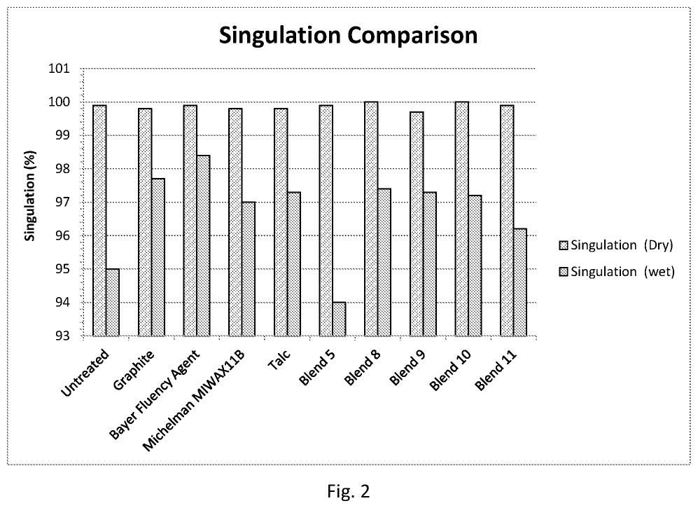

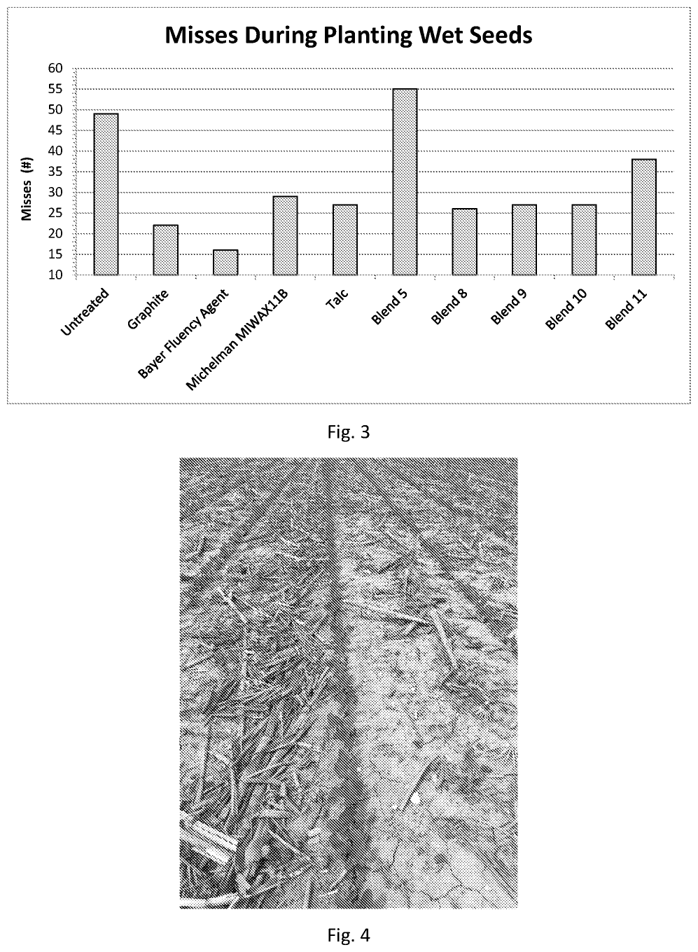

The results of this testing are shown in FIGS. 2 and 3. No differences were observed among the dry treatments. In wet conditions, the inventive blends were comparable to prior art products, but again avoiding the issues of those products.

### Example 4

### Field Trials

In this procedure, 50 lbs. (22.7 kg) of Blend 8 from Example 1 were transported to two different geographic locations (Wisconsin and Minnesota). At each location, the product was coated onto 22.7 kg corn or soybean seeds at a level of 0.375% by mixing the seeds with the Blend 8 powder in a planter box using a stirrer connected to a cordless drill. Second allotments of each of corn and soybean seeds were treated with an 80/20 talc/graphite mix to ensure successful planting and act as a control to determine the agronomical effects of the inventive blend.

Test sample seeds and control seeds were planted in each geographic location following the standard practice of the Grower in that location. All Growers reported that Blend 8 worked as expected as a seed lubricant, and no flow issues were observed. In one geographic location (Edgerton, MN), it had just finished raining and was 100% humid. Normally, the Grower would not have planted in those conditions but decided to proceed in this instance. The Grower was surprised at how well the Blend 8 seed planted during the humid conditions and reported that they were able to plant at normal speeds and achieve their target.

FIG. 4 is a photograph of the Blend 8 test soybean plants at the Wisconsin location at 2 weeks after planting. The soybean plants showed that the test seeds coated with Blend 8 had good singulation. The Blend 8 test corn plants at the same location showed similar singulation.

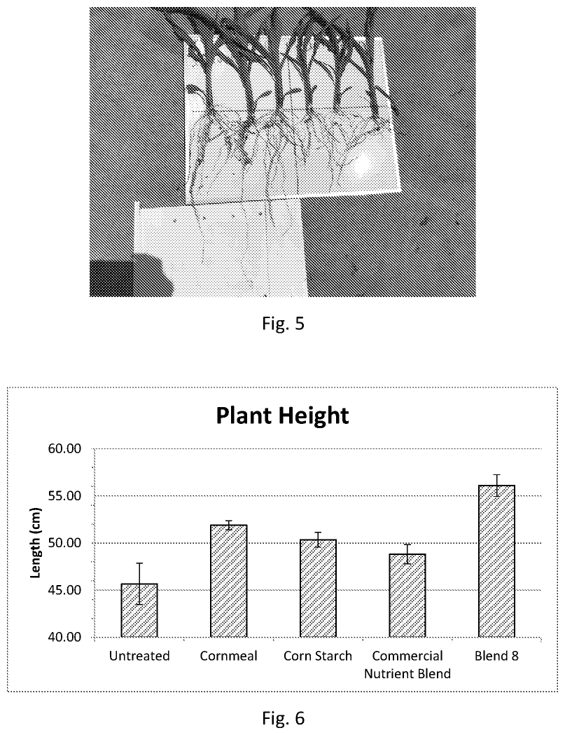

At 3 weeks after emergence, corn plants were harvested to compare the root structure of the Blend 8 plants to that of the control plants. The results were quite unexpected. The roots and shoots of the Blend 8 plants looked as if they were planted 1 week ahead of the control plants, even though they were planted on the same day (see FIG. 5; Blend 8 plants are the three on the left and control plants are the three on the right). Soybean plants also showed improved root structure as compared to the root structure of the control plants.

### Example 5

### Growth Chamber Studies

In light of the unexpected results in the field trials (Example 4), growth chamber studies were carried out to compare the inventive blend to a control and three prior art products. In this procedure, five test groups were created. Each group included corn seeds coated as shown in Table 2. In each instance, the quantities of the comparative treatments were adjusted as needed for each in order to keep the relevant component of that comparative treatment as the same level or rate (relative to the seeds) as the identical component of the Blend 8 treatment. In other words, the corn starch of the corn starch test sample was at the same loading on the seeds as the Blend & corn starch level; the cornmeal of the cornmeal sample was at the loading on the seeds as the Blend 8 cornmeal level; and the nutrient levels (i.e., P, N, Zn, and Mn) of the commercially available nutrient blend were the same loading on the seeds as those same nutrients in the Blend 8 treatment. This adjustment is reflected in the “Amount Added” column. Water was added to the corn starch, cornmeal, and commercial nutrient blend test samples to ensure the particular treatment adhered to the corn seed. The Blend 8 test sample had near 100% adhesion at 2 g per 1 kg of seeds, thus avoiding the need for water. For the untreated test sample, water was added merely to balance the total additive for each treatment to be 2 g per 1 kg of seed.

TABLE 2

| | Blend | Amount | | Water |
|---|---|---|---|---|
| Treatment | (w/w) | Added | | Added |
| Untreated | N/A | N/A | | 2.0 g/kg seed |
| Blend 8 | N/A | 2 | g/kg seed | — |
| Corn starch | 50 | 1 | g/kg seed | 1.0 g/kg seed |
| Cornmeal | 5 | 0.1 | g/kg seed | 1.9 g/kg seed |
| Commercial | 45 | 0.9 | g/kg seed | 1.1 g/kg seed |
| Nutrient Blend | | | | |

Coating was carried out as described in Example 2. After coating, six seeds of each test group were planted in identical soil in identical pots. Each test plant received the same environmental exposure during growth. The temperature in the greenhouse varied from 80° F. (26.7° C.) to 100° F. (37.8° C.), and the humidity varied from 50-80%. Each pot received 80 ml of water per day.

At 3 weeks after emergence, plants were harvested from all test groups, and the average plant height, average root area, average biomass, and average nutrient uptake of each test crop were determined for all treatments.

### 1. Plant Height

Plant height was determined by measuring the length of a single plant from the soil to the end point furthest from the stem or stalk of the highest leaf. This was done on six plants from each test crop, and the average of those six measurements was calculated and reported as the plant height for that particular treatment. These results are shown in FIG. 6.

### 2. Root Area

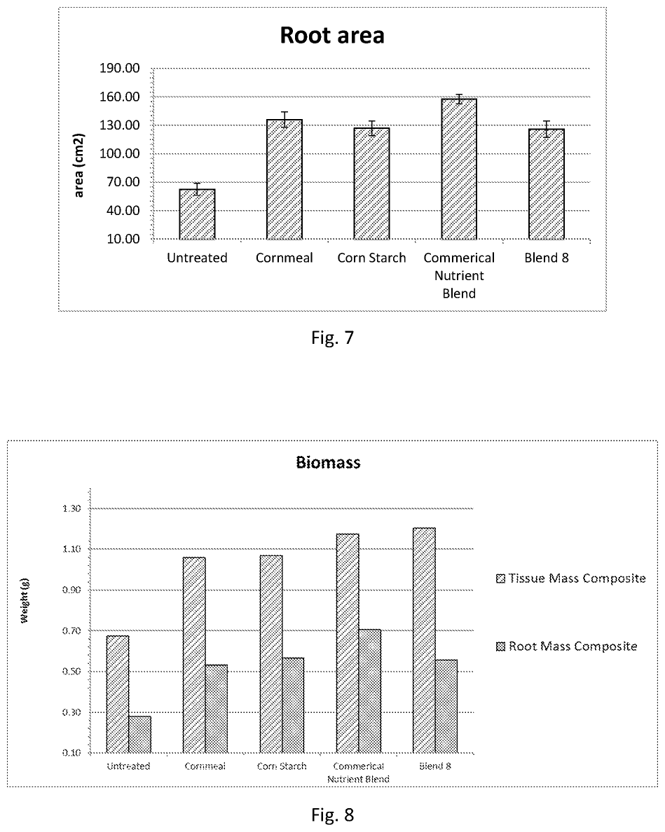

Root area was determined by scanning them with Epson Perfection V800 Photo scanner with a window size of 15×20 cm and analyzed with a WinRhizo Arabidopsis software package. This was done on six plants from each test crop, and the average of those six measurements was calculated and reported as root area for that particular test crop. These results are shown in FIG. 7.

### 3. Plant Biomass

The tissue and root mass of each test plant was determined by drying the above- and below-ground biomass for 12 hours at 220° C., then weighing each plant to the third decimal in grams. The average was calculated to report the plant biomass values. These results are shown in FIG. 8.

### 4. Elemental Analysis

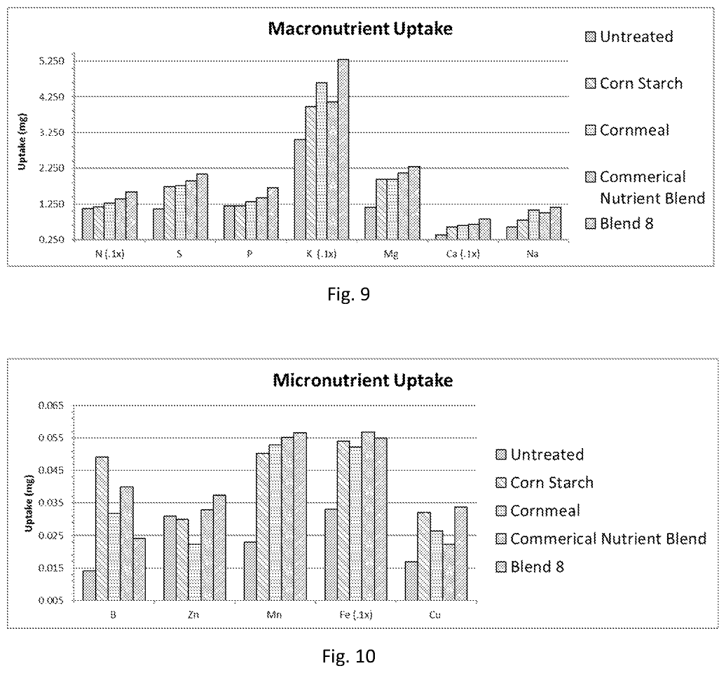

After drying, the test plants were ground to a fine powder and sent to a third-party lab (A&L Great Lakes Lab) for elemental analysis, which was determined by using approved Association of Official Analytical Chemists methods. Once these results were received, these results were used along with the above-ground tissue biomass numbers determined in Part 3 to calculate milligram (mg) of nutrient uptake for the various macronutrients and micronutrients. These results are shown in FIGS. 9 and 10. (Note: N, Ca, and K are present in such large quantities that they were divided by 10 so that they could be presented on the same graph as the other nutrients. This is designated by (0.1×) next to these elements in FIG. 9. This was also the case with Fe, as can be seen in FIG. 10.)

In order to determine the uptake attributable to each treatment, the respective levels of each nutrient present in the control plant was subtracted from the corresponding level in each test plant. Table 3 shows the mg update of each nutrient that was achieved on top of the control amount.

TABLE 3

| Treatment | N* | S* | P* | K* | Mg* | Ca* | Na* | B* | Zn* | Mn* | Fe* | Cu* |
|---|---|---|---|---|---|---|---|---|---|---|---|---|
| Control | 0.000 | 0.000 | 0.000 | 0.000 | 0.000 | 0.000 | 0.000 | 0.00000 | 0.00000 | 0.00000 | 0.00000 | 0.00000 |
| Corn Starch | 0.397 | 0.626 | 0.004 | 9.169 | 0.782 | 2.237 | 0.191 | 0.03502 | −0.00107 | 0.02733 | 0.20931 | 0.01522 |
| Cornmeal | 1.473 | 0.662 | 0.130 | 15.924 | 0.794 | 2.640 | 0.479 | 0.01759 | −0.00879 | 0.02998 | 0.19104 | 0.00960 |
| Commercial | 2.565 | 0.797 | 0.228 | 10.519 | 0.961 | 2.927 | 0.410 | 0.02576 | 0.00187 | 0.03226 | 0.23661 | 0.00546 |
| Nutrient Blend | | | | | | | | | | | | |
| Blend 8 | 4.581 | 0.978 | 0.517 | 22.428 | 1.147 | 4.485 | 0.556 | 0.00993 | 0.00632 | 0.03367 | 0.21862 | 0.01686 |
| Cumulative** | 4.436 | 2.084 | 0.361 | 35.612 | 2.537 | 7.804 | 1.080 | 0.078 | −0.008 | 0.090 | 0.637 | 0.030 |
| Uptake | | | | | | | | | | | | |

*All quantities are given in mg.
**Cumulative of com starch + cornmeal + commercial nutrient blend results.

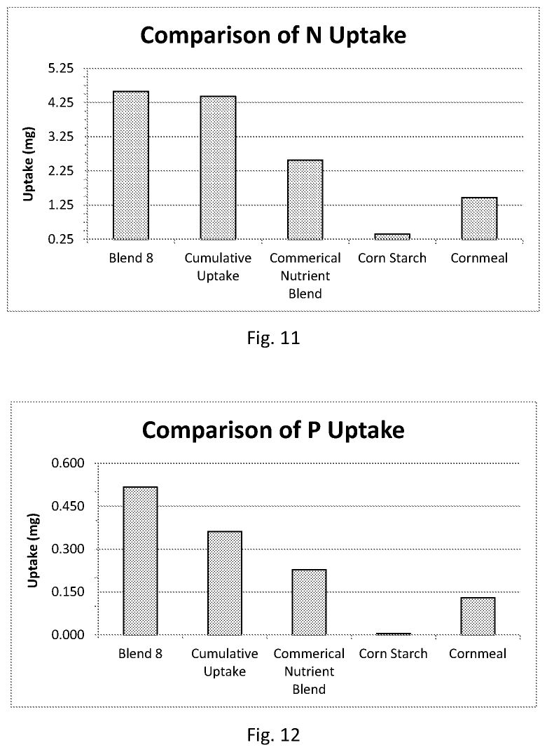

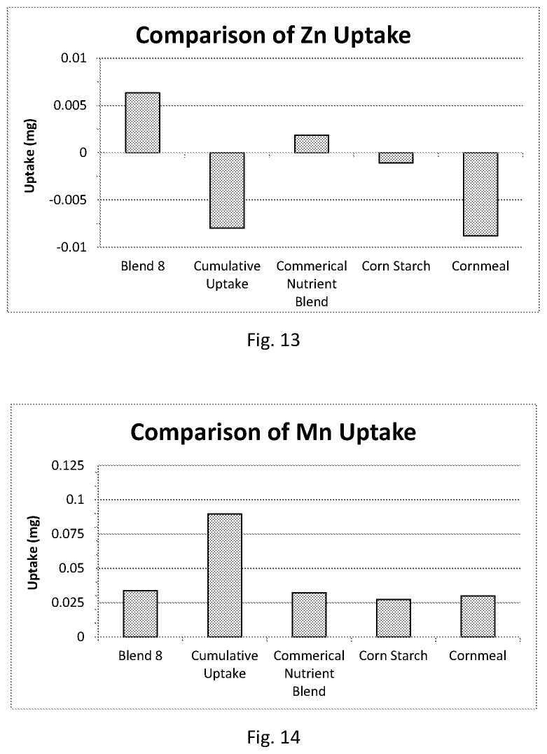

The N, P, Zn, and Mn levels by each test sample were assembled in graphs for comparison purposes. See FIGS. 11-14.

### Example 6

### Test Blends—Soybeans

Two additional formulations were prepared by first individually grinding the ingredients with a coffee grinder to a particle size of about 149 μm (100 mesh) or smaller. Each individually ground ingredient was then mixed together until substantially homogeneous mixtures were achieved. These formulations are shown in Table 4. In Examples 6-9, references Blends 12 or 13 are referring to those of Table 4.

TABLE 4

| | Blend 12 | Blend 13 |
|---|---|---|
| Raw Material | (w/w %) | (w/w %) |
| Nickel Acetate Tetrahydrate | 0.5 | — |
| Nickel Carbonate Basic | 1.8 | — |
| Cobalt Carbonate | 5 | — |
| Sodium Molybdate | 6 | 7.75 |
| Monoammonium Phosphate | 5 | 9.25 |
| Iron DDP^{A} | 8.5 | — |
| Protinus ®^{B} | 18.1 | — |
| Corn Starch^{C} | 50 | 50 |
| Corn Flour^{D} | 5 | 5 |
| Zinc Oxide | — | 12 |
| Zinc Sulfate Monohydrate | — | 4 |
| Manganese Chloride | — | 0.35 |
| Manganese Sulfate Monohydrate | — | 9 |
| Synthetic Iron Oxide | — | 2.3 |
| Iron Amino Acid Complex^{E} | — | 0.35 |

^{A}Includes sources of Fe obtained from Compass Minerals, Inc., Overland Park, KS.
^{B}Includes sources of Fe, Mn, and Zn obtained from Compass Minerals, Inc., Overland Park, KS.
^{C}Obtained from ARGO ®, MFG #2001567; UPC #761720073209.
^{D}Maseca ® Instant Masa Corn Flour, by Aztec Milling LP. Similar results were obtained with corn meal (Stone Ground Com Meal, white, by Palmetto Farms).
^{E}Sold under the name SoluKey ™ Fe by Balchem Corporation, New Hampton, NY.

### Example 7

### Flow Cone Studies—Soybeans

In each run of this test, flow cone studies were carried out to compare the formulations of Example 6 to a control. In each instance, 250 grams of dry soybean seeds was treated with the formulation to be tested by coating the seeds with 1 gram of the particular test treatment by shaking the soybean in a large plastic bag. The control sample was 250 gram of dry soybean seeds that received no seed flow aid treatment. These samples were used for the “dry” testing in the flow cone studies.

For the “wet,” studies, additional 250-gram samples were treated as described in the preceding paragraph except that 1 ml of water was added to the seeds after treatment but prior to the flow cone testing was carried out. Again, in this instance, the control sample did not receive a treatment coating, but it did have 1 ml of water added to it prior to flow cone testing.

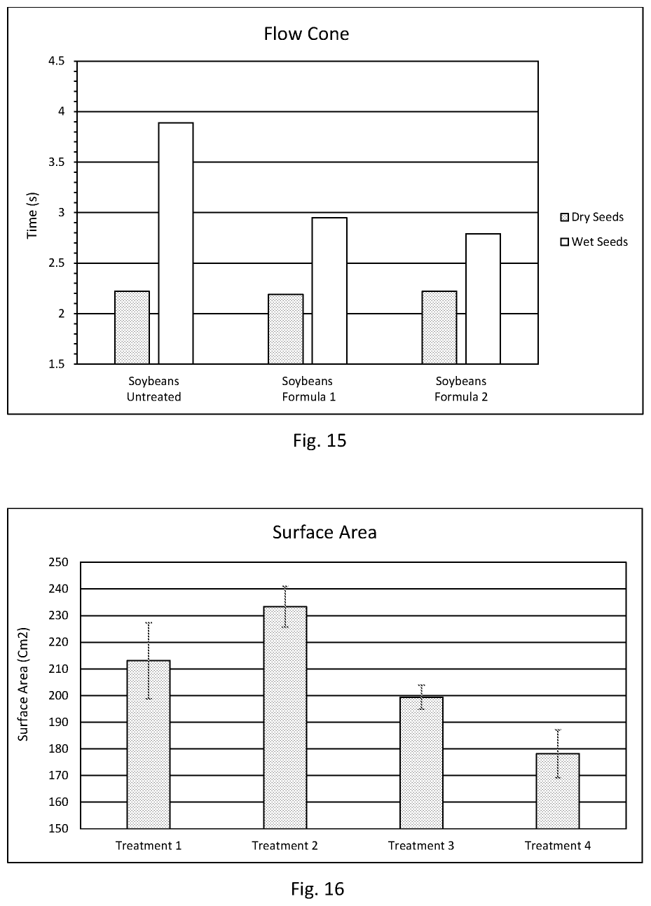

Flow cone testing of the samples was carried out using a 2-qt plastic funnel that had a 1-inch opening for the seeds to flow through. The opening was sealed with tape, and the tape was removed to initiate the test where time was measured until the cone was empty. The results of this testing are shown in FIG. 15, where it can be seen that the wet seeds flowed much more rapidly with treated according to the present disclosure that those seeds not receiving this treatment. Overall, these results show that the inventive blends with different variation of nutritionals offers a nutritional package that normally has detrimental effects as a seed lubricant.

### Example 8

### Greenhouse Study—Soybeans

An additional study was completed on soybeans to look into the effects the invented blends have on nodule development. In this procedure, soybean seeds were inoculated with and without bradyrhizobium. Water, red colorant, and bradyrhizobium (for Treatments 3 and 4 only) were mixed together at the rates shown in Table 5, thus forming a liquid slurry. Next, a 1-kg sample of soybean seeds was placed in a Wintersteiger Hege 11 liquid seed treater and spinning was commenced. The slurry was added to coat the spinning seeds. Once the seeds of Treatments 2 and 3 were uniformly coated, Inventive Blend 13 from Example 6 was added to the Wintersteiger Hege 11 liquid seed treater at a rate of 2 g/kg seed. It was observed that the sound of the spinning seeds changed nearly immediately from the sound of wet seeds to dry seeds. Additionally, the sound change indicated that the spin speed of the seeds increased upon treatment with Inventive Blend 13. After coating, ten seeds of each test group were planted in identical soil in identical pots.

TABLE 5

| | Treatment | Treatment | Treatment | Treatment |
|---|---|---|---|---|
| | 1 (g/Kg | 2 (g/Kg | 3 (g/Kg | 4 (g/Kg |
| Raw Material | Seed) | Seed) | Seed) | Seed) |
| Water | 6.5 | 6.5 | 5 | 5 |
| Red Colorant^{A} | 0.4 | 0.4 | 0.4 | 0.4 |
| Invented Blend | — | 2 | 2 | — |
| 13 from Table 4 | | | | |
| Bradyrhizobium | — | — | 1.5 | 1.5 |
| Liquid^{B} | | | | |

^{A}Sold under the name SUNAG ™ APE Free Red by Sun Chemicals.
^{B}Sold under the name PPST 120+ by Pioneer.

Each test plant received the same environmental exposure during growth. The temperature in the greenhouse varied from 80° F. (26.7° C.) to 100° F. (37.8° C.), and the humidity varied from 50-80%. Each pot received 80 mL of water per day. At 6 weeks after emergence, plants were harvested from all test groups, the average root area, average nodule count, average biomass, and average nutrient uptake of each test crop were determined for all treatments.

### 1. Root Area

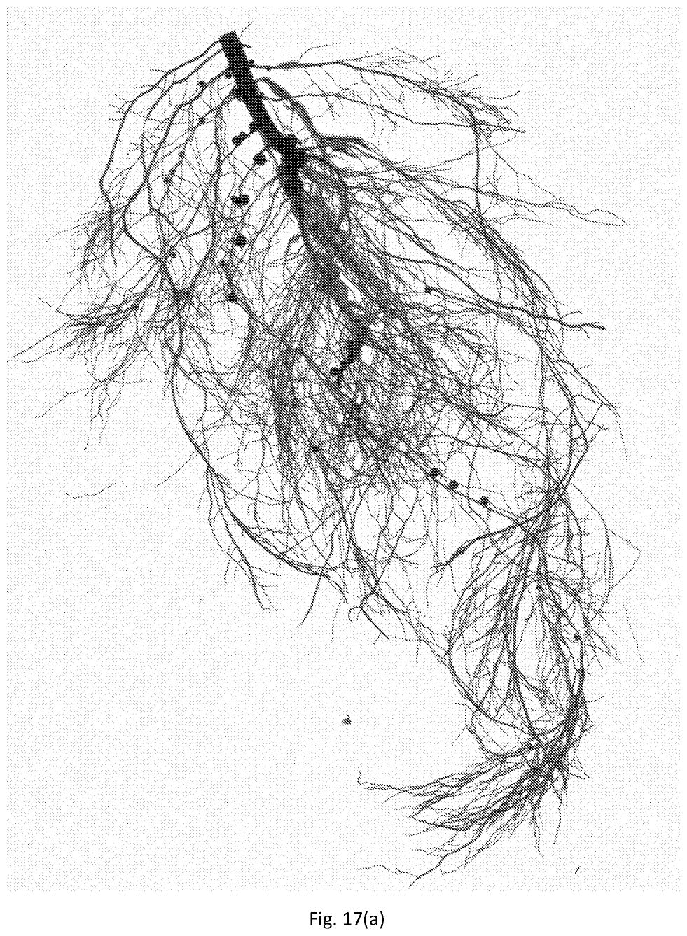

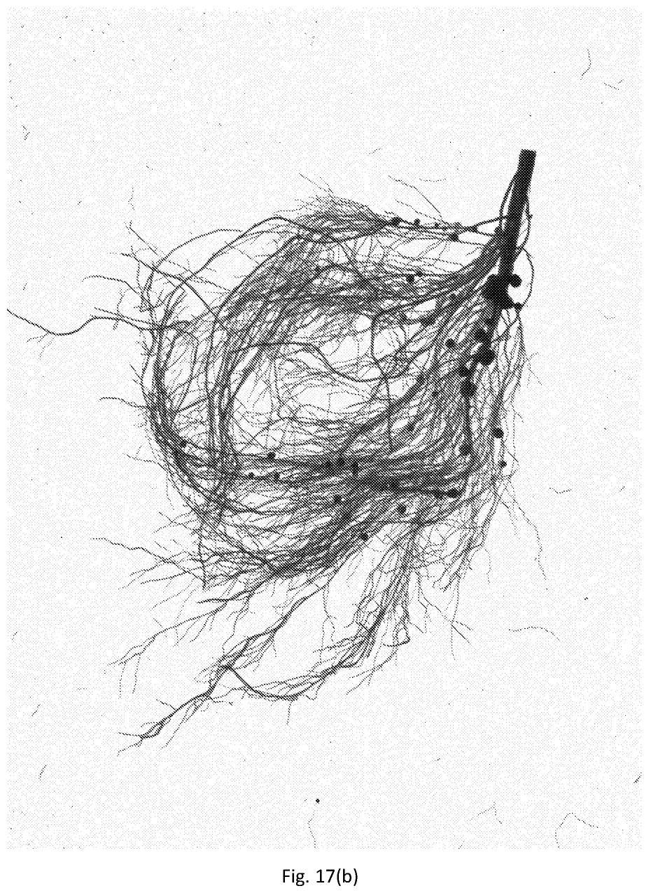

Root area was determined by scanning test plant roots with an Epson Perfection V800 Photo scanner with a window size of 15×20 cm and analyzed with a WinRhizo Arabidopsis software package. This was done on ten plants from each test crop, and the average of those ten measurements was calculated and reported as root area for that particular test crop. These results are shown in FIG. 16, while FIGS. 17(a) and 17(b) show pictures of the roots of two test plants. FIG. 16 shows that the Treatment 2 plant had a root area that was 9.5% greater than that of Treatment 1. Additionally, the Treatment 3 plant had a root area that as 11.9% greater than the Treatment 4 plant. FIGS. 17(a) and (b) provide a visual comparison of these differences. FIG. 17(a) shows the roots of a plant that received Treatment 2, which is dramatically improved over the roots of the plant receiving Treatment 1 (FIG. 17(b)).

### 2. Nodule Count

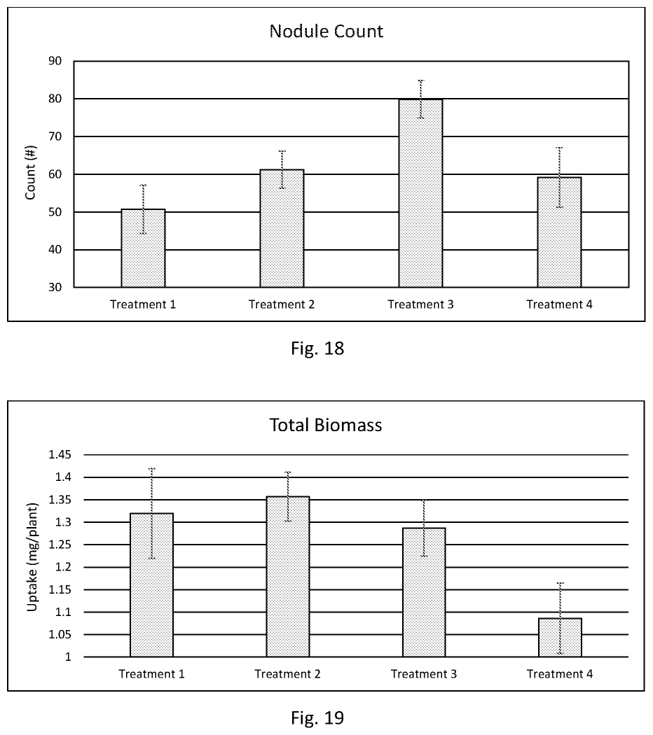

The WinRhizo Arabidopsis counted the nodules using the scanned images created as part of the root area analysis described above. Again, this was done on the same ten plants from each test crop, and the average of those ten measurements was calculated and reported for that particular test crop. These results are shown in FIG. 18. Again, Treatments 2 and 3 according to the inventive disclosure performed markedly better than their respective control counterparts Treatments 1 and 4. Treatment 2 resulted in plants with 20.7% more nodules than Treatment 1 plants, while Treatment 3 plants had 25.9% more nodules than Treatment 4 plants. Increased nodules will result in increased nitrogen uptake in plants.

### 3. Plant Biomass

The tissue and root mass of each test plant was determined by drying the above and below ground biomass for 12 hours at 220° C., then weighing each plant to the third decimal in grams. The average was calculated to report the plant biomass values. These results are shown in FIG. 19. Treatment 2 plants had a biomass that was 2.8% greater than the Treatment 1 plants, while the Treatment 3 plants had a biomass that was 18.4% greater than the Treatment 4 plants

### 4. Elemental Analysis

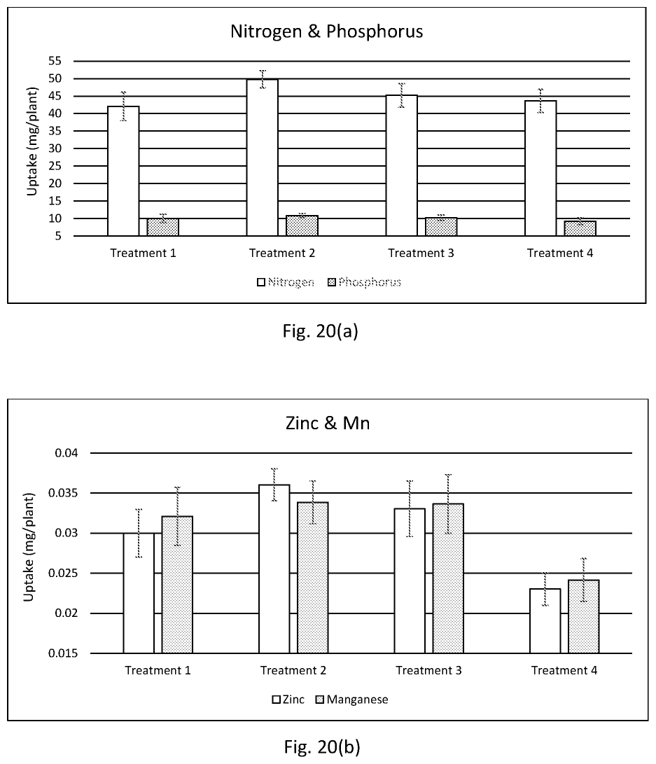

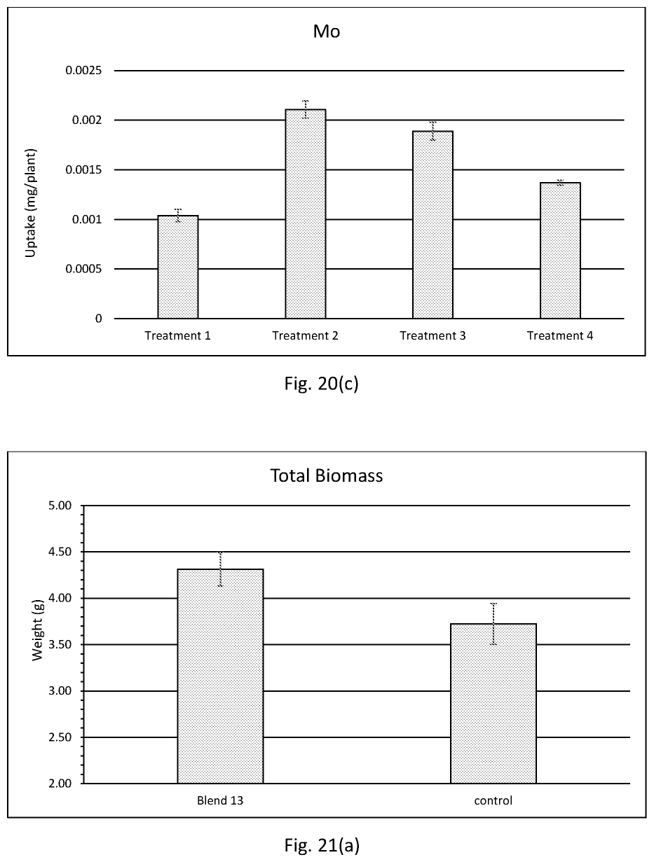

After drying, the test plants were ground to a fine powder and sent to a third-party lab (A&L Great Lakes Lab) for elemental analysis, which was determined by using approved Association of Official Analytical Chemists methods. These results were used along with the above ground tissue biomass numbers determined in Part 3 to calculate milligram (mg) of nutrient uptake for the various macronutrients and micronutrients. These results are shown in FIGS. 20(a)-(c).

Treatment 2 plants had a nitrogen uptake that was an 18.4% increase over that of the Treatment 1 plants, while the Treatment 3 plants had a nitrogen uptake that was 3.5% greater than the Treatment 4 plants.

Treatment 2 plants had a phosphorus uptake that was a 7.5% increase over that of the Treatment 1 plants, while the Treatment 3 plants had a nitrogen uptake that was 11.9% greater than the Treatment 4 plants.

Treatment 2 plants had a zinc uptake that was a 20.2% increase over that of the Treatment 1 plants, while the Treatment 3 plants had a zinc uptake that was 43.4% greater than the Treatment 4 plants.

Treatment 2 plants had a manganese uptake that was a 5.5% increase over that of the Treatment 1 plants, while the Treatment 3 plants had a manganese uptake that was 39.3% greater than the Treatment 4 plants.

Treatment 2 plants had a molybdenum uptake that was a 102% increase over that of the Treatment 1 plants, while the Treatment 3 plants had a molybdenum uptake that was 38% greater than the Treatment 4 plants.

### Example 9

### Greenhouse Study—Corn

Green house studies were carried out to compare Blend 13 from Table 4 to a control (i.e., identical treatments to the Blend 13 plant except no Blend 13 treatment was provided to the control). Corn seeds were coated as described in Example 2. After coating, eight seeds of each test group were planted in identical soil in identical pots. Each test plant received the same environmental exposure during growth. The temperature in the greenhouse varied from 80° F. (26.7° C.) to 100° F. (37.8° C.), and the humidity varied from 50-80%. Each pot received 80 mL of water per day.

At 6 weeks after emergence, plants were harvested from all test groups, and the average biomass and average nutrient uptake of each test crop were determined for all treatments.

### 1. Plant Biomass

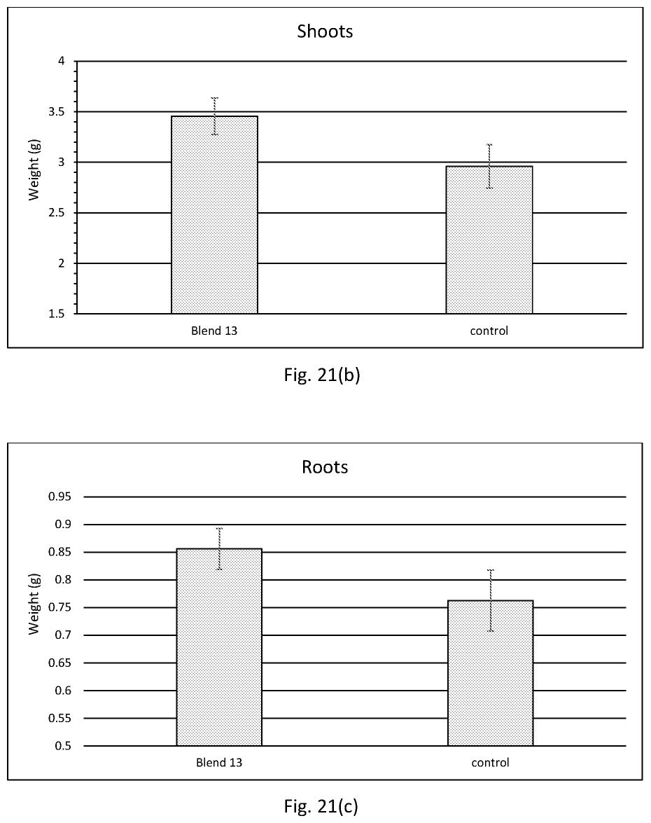

The tissue and root mass of each test plant was determined by drying the above and below ground biomass for 12 hours at 220° C., then weighing each plant to the third decimal in grams. The average was calculated to report the plant biomass values. These results are shown in FIG. 21(a)-(c). The Blend 13 plants had a biomass that was 15.9% greater than the Control plants.

### 2. Elemental Analysis

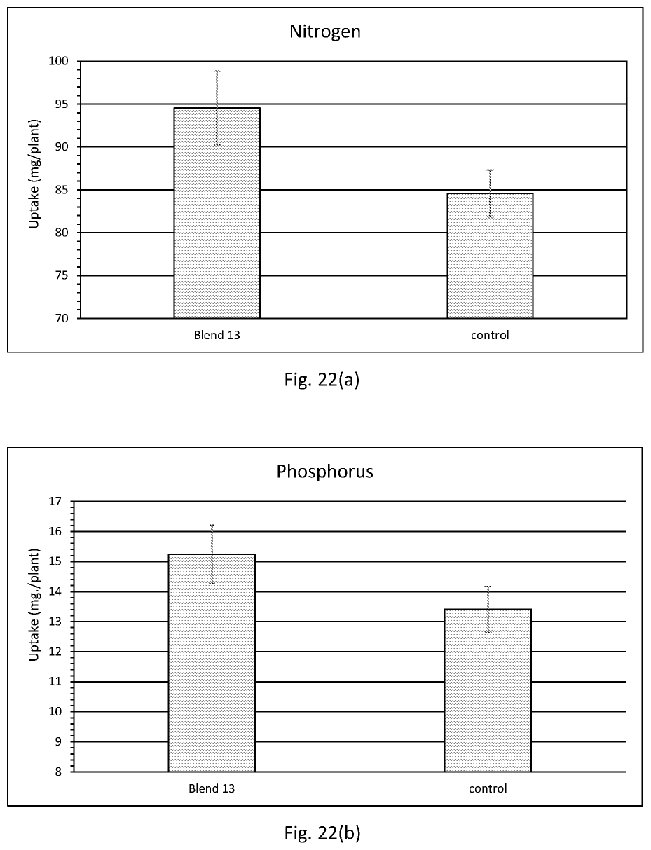

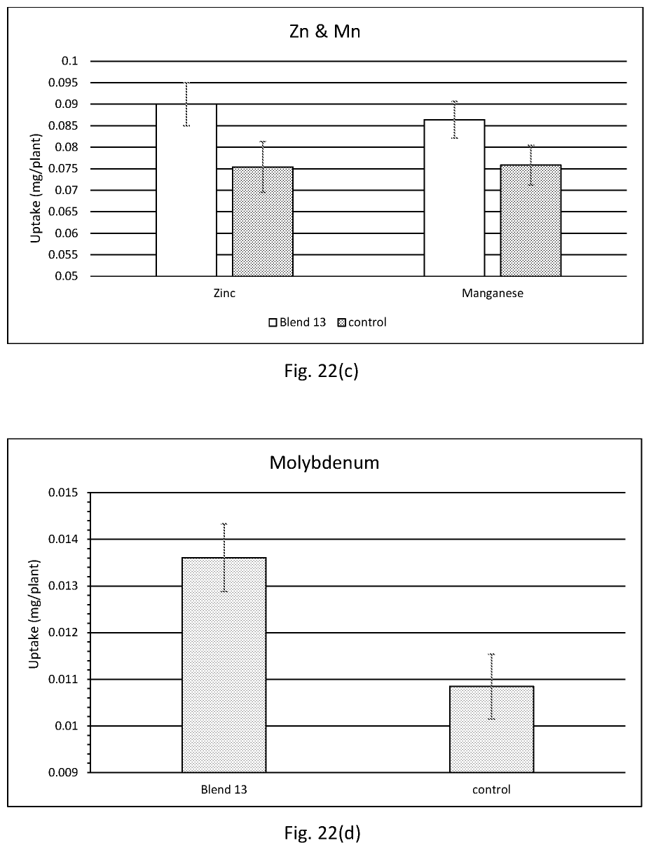

After drying, the test plants were ground to a fine powder and sent to a third-party lab (A&L Great Lakes Lab) for elemental analysis, which was determined using approved Association of Official Analytical Chemists methods. These results were used, along with the above ground tissue biomass numbers determined in Part 3, to calculate milligram (mg) of nutrient uptake for the various macronutrients and micronutrients. These results are shown in FIGS. 22(a)-(d).

The Blend 13 plants had:
a nitrogen uptake that was an 11.8% increase over that of the Control plants;
a phosphorus uptake that was a 13.6% increase over that of the Control plants,
a zinc uptake that was a 20% increase over that of the Control plants;
a manganese uptake that was a 13.2% increase over that of the Control plants; and
a molybdenum uptake that was an 27.3% increase over that of the Control plants.

### Example 10

### Alternative Formulations

Tables 6 and 7 show two additional seed treatment compositions that can be formulated according to the disclosure. These formulations can be prepared by following the procedures described in Example 1.

TABLE 6

| INGREDIENT | % BY WEIGHT^{A} |
|---|---|
| Ultra-fine, unmodified cornstarch | 34 |
| Corn flour^{B} | 5 |
| Protinus ®^{C} | 45 |
| Mica coated with TiO₂^{D} | 15 |
| Red Colorant^{E} | 1 |

^{A}All % by weight are based on the total weight of the formulation taken as 100% by weight.
^{B}Maseca ® Instant Masa Corn Flour, by Aztec Milling LP.
^{C}Includes sources of Fe, Mn, and Zn obtained from Compass Minerals, Inc., Overland Park, KS.
^{D}Provides shine.
^{E}Sold under the name OrcoPerm ™ FGR (CAS #6535-46-2) by Organic Dyes & Pigments, Lincoln, RI.

TABLE 7

| INGREDIENT | % BY WEIGHT^{A} |
|---|---|
| Cornstarch | 17.48 |
| Corn flour^{B} | 5.0 |
| Sodium Molybdate Dihydrate | 7.75 |
| Monoammonium Phosphate | 9.25 |
| Zinc Oxide | 12.0 |
| Zinc Sulfate Monohydrate | 4.0 |
| Manganese Chloride | 0.35 |
| Manganese Sulfate Monohydrate | 9.0 |
| Iron Sulfate Monohydrate | 4.83 |
| Chelated Iron^{C} | 0.35 |
| Mica coated with TiO₂^{D} | 30.0 |

^{A}All % by weight are based on the total weight of the formulation taken as 100% by weight.
^{B}Maseca ® Instant Masa Corn Flour, by Aztec Milling LP.
^{C}Sold under the name KeyShure ® Fe by Balchem Corporation, New Hampton, NY.
^{D}Provides shine.

### DISCUSSION

The testing showed that the inventive seed treatment composition worked well as a seed lubricant or flow aid, thus making it a viable candidate for replacing prior art wax, talc, and graphite products but without duplicating the problems associated with these prior art products. The inventive seed treatment compositions provided excellent seed flow and singulation.

This testing had the added benefit of showing that this could be achieved in the presence

We claim:

1. A method of improving seed flow comprising contacting a plurality of seeds having respective outer surfaces with a seed treatment composition comprising from about 20% to about 70% by weight of a ground corn component; from about 0.01% to about 15% by weight of zinc; from about 0.01% to about 15% by weight of manganese; and optionally from about 0.01% to about 15% by weight molybdenum, based upon the total weight of the seed treatment composition taken as 100% by weight;
wherein the seed treatment composition comprises 0% by weight of waxes, carbonaceous materials, silicon-containing compounds, microorganisms, and polymers, other than those naturally present in the ground corn component; and
wherein the seeds are dry during contacting and wherein the method results in seeds having a singulation rate of at least about 95%.

2. The method of claim 1, wherein the seed treatment composition further comprises at least one plant nutrient selected from the group consisting of sources of nickel, copper, boron, iron, chloride, selenium, calcium, sulfur, phosphorus, magnesium, potassium, nitrogen, and mixtures thereof.

3. The method of claim 1, wherein the ground corn component is selected from the group consisting of corn starch, cornmeal, and mixtures thereof.

4. The method of claim 1, wherein the seed treatment composition is a dry, particulate composition.

5. The method of claim 1, wherein the seeds are selected from the group consisting of corn seeds, soybean seeds, cotton seeds, fruit seeds, wheat seeds, and vegetable seeds.

6. The method of claim 1, further comprising planting the seeds after said contacting.

7. The method of claim 6, wherein about 3 weeks after planting, at least some of the seeds grow into plants that are at least about 8% taller than if the seeds had been planted without using the seed treatment composition.

8. The method of claim 6, wherein about 3 weeks after planting, at least some of the seeds grow into plants having a root area that is at least about 9.5% greater than if the seeds had been planted without using the seed treatment composition.

9. A method of improving seed flow comprising contacting a plurality of seeds having respective outer surfaces with a seed treatment composition comprising from about 20% to about 70% by weight of a ground corn component; from about 0.01% to about 15% by weight of zinc; from about 0.01% to about 15% by weight of manganese; and optionally from about 0.01% to about 15% by weight molybdenum, based upon the total weight of the seed treatment composition taken as 100% by weight;
wherein the seed treatment composition comprises 0% by weight of silicon-containing compounds, microorganisms, and polymers, other than those naturally present in the ground corn component; and
wherein the seeds are dry during contacting and wherein the method results in seeds having a singulation rate of at least about 95%.

10. The method of claim 9, wherein the seed treatment composition further comprises at least one plant nutrient selected from the group consisting of sources of nickel, copper, boron, iron, chloride, selenium, calcium, sulfur, phosphorus, magnesium, potassium, nitrogen, and mixtures thereof.

11. The method of claim 9, wherein the seed treatment composition further comprises graphite.

12. The method of claim 9, wherein the ground corn component is selected from the group consisting of corn starch, cornmeal, and mixtures thereof.

13. The method of claim 9, wherein the seed treatment composition is a dry, particulate composition.

14. The method of claim 9, wherein the seeds are selected from the group consisting of corn seeds, soybean seeds, cotton seeds, fruit seeds, wheat seeds, and vegetable seeds.

15. The method of claim 9, further comprising planting the seeds after said contacting.

16. The method of claim 15, wherein about 3 weeks after planting, at least some of the seeds grow into plants that are at least about 8% taller than if the seeds had been planted without using the seed treatment composition.

17. The method of claim 15, wherein about 3 weeks after planting, at least some of the seeds grow into plants having a root area that is at least about 9.5% greater than if the seeds had been planted without using the seed treatment composition.

18. A method of improving seed flow comprising contacting a plurality of seeds having respective outer surfaces with a seed treatment composition comprising from about 15% to about 50% by weight of a ground corn component; from about 30% to about 60% by weight of a plant nutrient; and from about 5% to about 40% by weight of mica coated with TiO₂, based upon the total weight of the seed treatment composition taken as 100% by weight.

19. The method of claim 18, wherein the plant nutrient is selected from the group consisting of sources of nickel, copper, zinc, manganese, boron, iron, chloride, selenium, molybdenum, calcium, sulfur, phosphorus, magnesium, potassium, nitrogen, and mixtures thereof.

20. The method of claim 19, wherein the seed treatment composition comprises from about 0.01% to about 15% by weight of zinc; from about 0.01% to about 25% by weight of manganese; and optionally from about 0.01% to about 15% by weight molybdenum, based upon the total weight of the seed treatment composition taken as 100% by weight.

21. The method of claim 18, wherein the ground corn component is selected from the group consisting of corn starch, cornmeal, and mixtures thereof.

22. The method of claim 18, wherein the seed treatment composition is a dry, particulate composition.

23. The method of claim 18, wherein the seeds are selected from the group consisting of corn seeds, soybean seeds, cotton seeds, fruit seeds, wheat seeds, and vegetable seeds.
